(19) United States
(12) Patent Application Publication
(10) Pub. No.: US 2021/0081235 A1
(43) Pub. Date: Mar. 18, 2021

(54) MEMORY SYSTEM

(71) Applicant: Kioxia Corporation, Minato-ku (JP)

(72) Inventors: Masataka GOTO, Yokohama (JP); Takahiro YAMAURA, Kawasaki (JP)

(73) Assignee: Kioxia Corporation, Minato-ku (JP)

(21) Appl. No.: 16/811,734

(22) Filed: Mar. 6, 2020

(30) Foreign Application Priority Data
Sep. 12, 2019 (JP) 2019-166651

(51) Int. Cl. G06F 9/48; G06F 9/54; G06F 13/16; G06F 12/02

(52) U.S. Cl. CPC G06F 9/4825; G06F 9/4818; G06F 12/0253; G06F 9/546; G06F 13/1689; G06F 9/485

(57) ABSTRACT

According to one embodiment, a memory system includes a non-volatile memory and a memory controller. The memory controller acquires each of one or more first commands for execution from a plurality of queues storing the one or more first commands at timing based on first information. The one or more first commands include a second command from a host. The second command is a command requiring an access to the non-volatile memory for being executed. The first information serves to define, for each of the queues, a periodic temporal section in which execution of a first command is permissible.

### CROSS-REFERENCE TO RELATED APPLICATIONS

This application is based upon and claims the benefit of priority from Japanese Patent Application NO. 2019-166651, filed Sep. 12, 2019, the entire contents of which are incorporated herein by reference.

### FIELD

Embodiments described herein relate generally to a memory system.

### BACKGROUND

Conventionally, a memory system that receives commands for respective namespaces via different queues is known. Such a memory system implements priority control by assigning priority to each queue. However, after starting executing a command with lower priority, such a memory system cannot start execution of a command with higher priority until completing the command with lower priority. That is, the memory system cannot ensure a length of time for completing the execution of the command with higher priority.

### BRIEF DESCRIPTION OF THE DRAWINGS

FIG. 1 is a schematic diagram illustrating an exemplary hardware configuration of an information processing apparatus incorporating a memory system according to an embodiment;

FIG. 2 is a schematic diagram illustrating an exemplary hardware configuration of the memory system of the embodiment;

FIG. 3 is a schematic diagram illustrating an exemplary configuration of one die according to an embodiment;

FIG. 4 is a schematic diagram illustrating an exemplary functional configuration of the information processing apparatus according to an embodiment;

FIG. 5 is a schematic diagram illustrating an exemplary configuration of a queue unit according to an embodiment;

FIG. 6 is a diagram illustrating exemplary information to transmit and receive between a host and the memory system of the embodiment;

FIG. 7 is a schematic diagram illustrating exemplary block management information according to an embodiment;

FIG. 8 is a schematic diagram illustrating an exemplary translation table according to an embodiment;

FIG. 9 is a flowchart illustrating an exemplary operation of the memory system of the embodiment, in response to an operation request setting command;

FIG. 10 is a flowchart illustrating an exemplary operation of the memory system of the embodiment for generating operation control information;

FIG. 11 is a diagram illustrating exemplary one or more operation requests in the embodiment;

FIG. 12A is a diagram illustrating exemplary operation control information being generated in the embodiment;

FIG. 12B is a diagram illustrating exemplary operation control information being generated in the embodiment;

FIG. 12C is a diagram illustrating exemplary operation control information being generated in the embodiment;

FIG. 12D is a diagram illustrating exemplary operation control information being generated in the embodiment;

FIG. 12E is a diagram illustrating exemplary generated operation control information according to an embodiment;

FIG. 13 is a diagram illustrating exemplary processing-time information according to an embodiment;

FIG. 14 is a flowchart illustrating an exemplary scheduling operation performed by the memory system of the embodiment;

FIG. 15 is a diagram illustrating an exemplary command execution status according to an embodiment;

FIG. 16 is a diagram illustrating exemplary schedule information according to an embodiment;

FIG. 17 is a diagram illustrating an exemplary operation of a command execution unit according to an embodiment;

FIG. 18 is a schematic diagram illustrating an exemplary functional configuration of an information processing apparatus according to a first modification;

FIG. 19 is a schematic diagram illustrating an exemplary connection between a memory system and an information processing apparatus according to a second modification;

FIG. 20 is a schematic diagram illustrating exemplary functional configurations of the memory system and the information processing apparatus according to the second modification;

FIG. 21 is a schematic diagram illustrating exemplary functional configurations of a memory system and an information processing apparatus according to a third modification; and

FIG. 22 is a schematic diagram illustrating exemplary functional configurations of a memory system and an information processing apparatus according to a fourth modification.

### DETAILED DESCRIPTION

According to one embodiment, in general, a memory system includes a non-volatile memory and a memory controller. The memory controller acquires each of one or more first commands for execution from a plurality of queues storing the one or more first commands at timing based on first information. The one or more first commands include a second command from a host. The second command is a command requiring an access to the non-volatile memory for being executed. The first information serves to define, for each of the queues, a periodic temporal section in which execution of a first command is permissible.

Exemplary embodiments of a memory system will be explained in detail below with reference to the accompanying drawings. The following embodiments are merely exemplary and not intended to limit the scope of the present invention.

### Embodiment

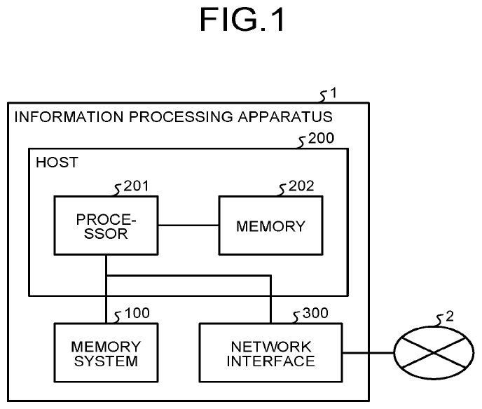

FIG. 1 is a schematic diagram illustrating an exemplary hardware configuration of an information processing apparatus incorporating a memory system according to an embodiment. An information processing apparatus 1 represents, for example, an information processing apparatus for automobile use, for industrial use, for communication use, for medical use, or for power supply. Applications of the information processing apparatus 1 are not limited to such examples.

The information processing apparatus 1 includes a host 200, a memory system 100, and a network interface 300. The host 200 includes a processor 201 and a memory 202.

The processor 201 and the memory 202 are connected to each other via a memory bus. The processor 201 and the memory system 100 as well as the processor 201 and the network interface 300 are connected to each other via an internal bus such as PCI Express (registered trademark). The network interface 300 is connected to a network 2 via, for example, Ethernet (registered trademark).

The memory system 100 is, for example, a solid state drive (SSD) including a non-volatile memory such as a NAND flash memory as a storage. The memory as a non-volatile memory is not limited to a NAND flash memory. Examples of non-volatile memory may include a NOR flash memory, a ferroelectric random access memory (FeRAM), a magnetoresistive random access memory (MRAM), a phase-change memory (PCM), and a resistive random access memory (ReRAM).

The connection between the host 200 and the memory system 100 is compliant with NVM Express (registered trademark), for example. The memory system 100 serves to support a separation function on a namespace basis defined by NVM Express (registered trademark), for example.

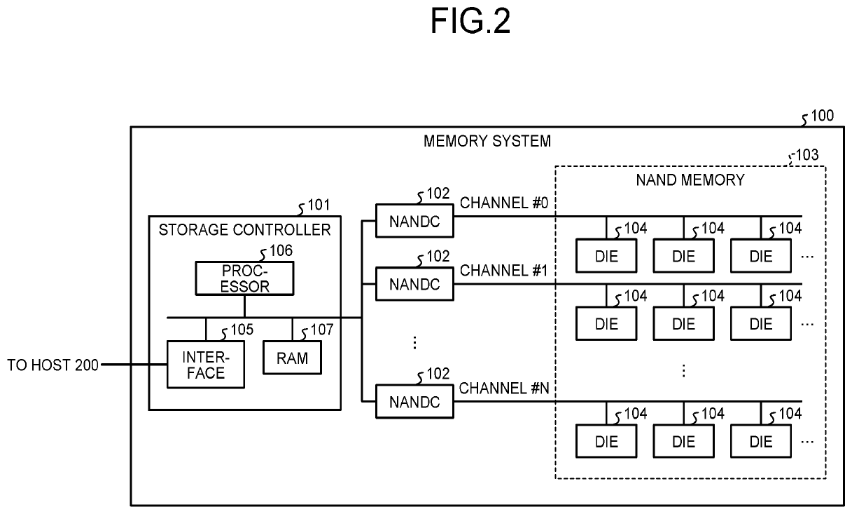

FIG. 2 is a schematic diagram illustrating an exemplary hardware configuration of the memory system 100 of the embodiment.

The memory system 100 includes a storage controller 101, one or more NAND controllers 102, and a NAND flash memory (hereinafter, referred to as a NAND memory) 103.

The storage controller 101 is an exemplary memory controller in the embodiment. The NAND memory 103 is an exemplary non-volatile memory in the embodiment.

The NAND memory 103 includes a plurality of dies 104.

In FIG. 2, as an example, the memory system 100 includes N+1 NAND controllers 102 as the one or more NAND controllers 102. One or more dies 104 are commonly connected to each NAND controller 102 through a channel. The NAND controllers 102 each control the one or more dies 104 connected thereto. The NAND controllers 102 provide the storage controller 101 with an access function to the NAND memory 103. Connections between the NAND controllers 102 and the die 104 are not limited to this example.

The storage controller 101 serves to control data transfer between the host 200 and each NAND memory 103. For this purpose, the storage controller 101 includes an interface controller 105, a processor 106, and a random access memory (RAM) 107.

The processor 106 performs the overall control of the storage controller 101 by firmware serving as a computer program. For example, the firmware is stored in a non-volatile memory such as the NAND memory 103. The processor 106 loads the firmware from the non-volatile memory to a volatile memory such as the RAM 107 upon booting of the memory system 100. The processor 106 executes the firmware loaded to the RAM 107, thereby implementing the overall control over the storage controller 101. The functional configuration of the storage controller 101 will be described later.

The RAM 107 functions as a data transfer buffer between the host 200 and the NAND memory 103 and as a work area for the processor 106.

The storage controller 101 can be configured as, for example, a system-on-a-chip (SoC). The storage controller 101 may include two or more chips. For example, the RAM 107 and the storage controller 101 may be formed of different chips. The storage controller 101 and the NAND controller 102 may be included in the same chip. Further, the storage controller 101 may include a field-programmable gate array (FPGA) or an application specific integrated circuit (ASIC), instead of the processor 106. That is, the storage controller 101 can be implemented by software, hardware, or a combination thereof.

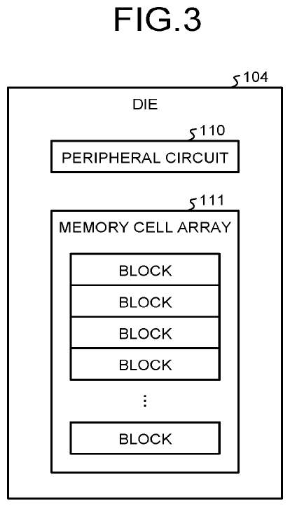

FIG. 3 is a schematic diagram illustrating an exemplary configuration of one die 104 in the embodiment. The die 104 includes a memory cell array 111 as storage, and a peripheral circuit 110 that reads and writes data from and to the memory cell array 111. The peripheral circuit 110 includes, for example, a row decoder, a column decoder, a sense amplifier, and a voltage generation circuit.

The memory cell array 111 includes a plurality of blocks. All the data stored in each block is erased at once. Each block includes a plurality of pages. Each page serves as a minimum unit of data write and read.

The memory cell array 111 may be divided into two or more planes each including two or more blocks. The peripheral circuit 110 may be configured to be able to write, read, and erase data with respect to the planes independently.

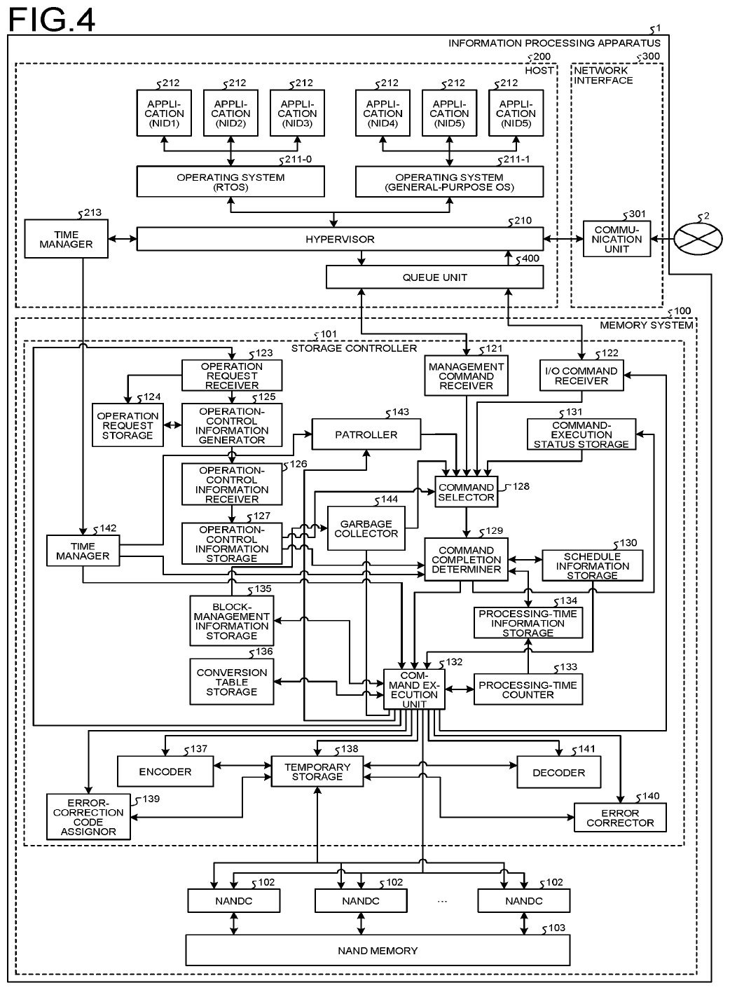

FIG. 4 is a schematic diagram illustrating an exemplary functional configuration of the information processing apparatus 1 of the embodiment. The schematic functional configuration of the information processing apparatus 1 will be described with reference to FIG. 4.

In the host 200 a hypervisor 210 is in operation. The host 200 includes the hypervisor 210 to be able to operate multiple operating systems (OS) 211. Herein, multiple OSs 211 are an OS 211-0 and an OS 211-1. Each of the OS 211-0 and the OS 211-1 serves to manage the resources of the host 200 and provides an application interface (to be described later) and a user interface.

The OS 211-0 serves as a real-time OS. That is, the OS 211-0 imposes temporal restriction on execution of processing. Thus, commands issued via the OS 211-0 are to be completed within a given length of time.

The OS 211-1 serves as a general-purpose OS and a non-real-time OS. Command issued via the OS 211-1 are not subjected to temporal restriction.

In the host 200, three applications 212 are in operation on the OS 211-0, and three applications 212 are in operation on the OS 211-1.

The six applications 212 can use mutually different namespaces. The namespaces are identified by identification (ID). A namespace ID is abbreviated as NID. The three applications 212 operating on the OS 211-0 use namespaces NID #1, NID #2, and NID #3, respectively. The three applications 212 operating on the OS 211-1 use namespaces NID #4, NID #5, and NID #6, respectively.

The host 200 includes a queue unit 400. The queue unit 400 includes a plurality of queues containing commands to be executed by the storage controller 101. An exemplary configuration of the queue unit 400 will be described later.

The host 200 includes a time manager 213. The time manager 213 manages time for use in the host 200. The time manager 213 serves as, for example, a timer.

The hypervisor 210, the two OSs 211-0 and 211-1, the six applications 212, and the time manager 213 are implemented by the processor 201's execution of a computer program stored in the memory 202, for example. The time manager 213 may be implemented by hardware circuitry. The queue unit 400 includes, for example, the memory 202 or an optional memory, or a register different from the memory 202.

The network interface 300 functions as a communication unit 301 for the host 200 to connect to the network 2.

The storage controller 101 includes a management command receiver 121, an I/O command receiver 122, an operation request receiver 123, an operation request storage 124, an operation-control information generator 125, an operation-control information receiver 126, an operation-control information storage 127, a command selector 128, a command-completion determiner 129, a schedule-information storage 130, a command-execution status storage 131, a command execution unit 132, a processing-time counter 133, a processing-time information storage 134, a block-management information storage 135, a translation-table storage 136, an encoder 137, a temporary storage 138, an error-correction code assignor 139, an error corrector 140, a decoder 141, a time manager 142, a patroller 143, and a garbage collector 144.

Part or all of the operation request storage 124, the operation-control information storage 127, the block-management information storage 135, the translation-table storage 136, the temporary storage 138, the command-execution status storage 131, the schedule-information storage 130, and the processing-time information storage 134 can be implemented by the RAM 107 or a smaller-size volatile memory different from the RAM 107.

Alternatively, part or all of these storages can be placed in a non-volatile memory such as the NAND memory 103. In this case, information stored in these storages may be cached in the RAM 107.

Part or all of the management command receiver 121, the I/O command receiver 122, the operation request receiver 123, the operation-control information generator 125, the operation-control information receiver 126, the command selector 128, the command-completion determiner 129, the command execution unit 132, the processing-time counter 133, the encoder 137, the error-correction code assignor 139, the error corrector 140, the decoder 141, the time manager 142, the patroller 143, and the garbage collector 144 can be implemented by the processor 106's execution of firmware. Part or all of these functional elements can be implemented by hardware circuitry.

The management command receiver 121 receives a management command, stored in the queue unit 400, for the memory system 100 from the host 200. The management command includes, for example, a namespace creation command for creating a namespace, a queue creation command for creating various queues, and an operation request setting command.

The I/O command receiver 122 receives an I/O command for the memory system 100 from the host 200. The I/O command includes a write command for requesting data write and a read command for requesting data read.

The management command receiver 121 and the I/O command receiver 122 receive the management command and the I/O command via a plurality of queues of the queue unit 400, respectively.

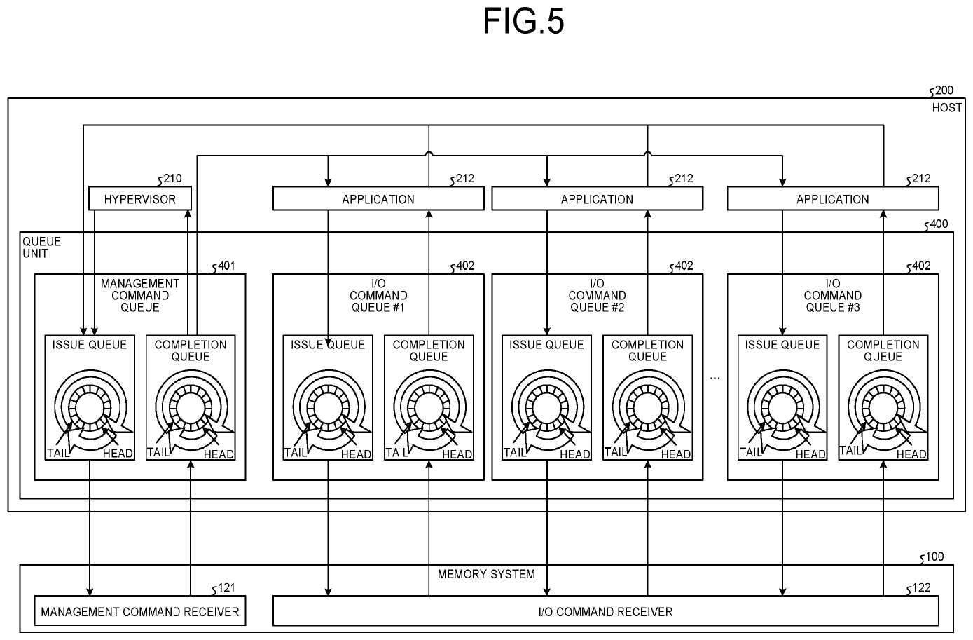

FIG. 5 is a schematic diagram illustrating an exemplary configuration of the queue unit 400 in the embodiment. In FIG. 5, as an example, the queue unit 400 includes one management command queue 401 and three I/O command queues 402. Herein, the host 200 includes the queue unit 400. The memory system 100 may include the queue unit 400 instead. Alternatively, the host 200 may include part of the queues of the queue unit 400, and the memory system 100 may include another part of the queues of the queue unit 400.

The hypervisor 210 stores a management command in the management command queue 401, for example. The management command receiver 121 receives a management command via the management command queue 401. The application 212 stores an I/O command in the I/O command queue 402. The I/O command receiver 122 receives an I/O command via the I/O command queue 402.

More specifically, the management command queue 401 and the I/O command queue 402 can each include a pair of an issue queue and a completion queue. The issue queue refers to a queue containing commands issued from the host 200 to the memory system 100. The completion queue refers to a queue containing completion notices of command execution. The memory system 100 receives a command via the issue queue and stores a completion notice in the completion queue after completion of the execution of the command. The host 200 can recognize completion of a command execution by checking the notice in the completion queue.

In the example of FIG. 5 one application 212 uses one I/O command queue 402. However, one application 212 may use two or more I/O command queues 402. For example, one application 212 may use different I/O command queues 402 in data write and data read.

The issue queue and the completion queue serve as ring buffers, as an example. Entries of the issue queue and the completion queue are classified into entries of the memory system 100 and entries of the host 200 by two variables, i.e., Head and Tail. Entries from Head to Tail-1 represent entries belonging to the memory system 100. Entries from Tail to Head-1 represent entries belonging to the host 200. The term “belonging to” signifies holding the right of use.

For example, regarding the issue queue, the host 200 writes a command to an entry indicated by a current Tail value and notifies the memory system 100 of an entry number of a written command as a Tail value, to thereby request the memory system 100 for processing the command. The memory system 100 acquires and receives commands in order starting from an entry indicated by a current Head value. The memory system 100 notifies the host 200 of an entry number of a received and stored command as a Head value.

As for the completion queue, the memory system 100 notifies the host 200 of an entry number of an executed command as a Head value. After executing a command in response to a notice, the host 200 notifies the memory system 100 of an entry number of the executed command as a Tail value.

Although not illustrated in FIG. 5, the queue unit 400 includes a garbage collection queue and a patrol queue. The garbage collection queue and the patrol queue may be placed in different locations from the management command queue 401 and the I/O command queue 402. The garbage collection queue and the patrol queue are placed in the memory system 100, for example.

Hereinafter, the queue refers to the management command queue 401, the I/O command queue 402, the patrol queue, or the garbage collection queue, unless otherwise mentioned.

Referring back to FIG. 4, the operation request receiver 123 receives an operation request contained in the operation request setting command and stores the operation request in the operation request storage 124. In addition, the operation request receiver 123 notifies the operation-control information generator 125 of the receipt of the operation request.

The operation request represent characteristics required for the management command queue 401 or the I/O command queue 402. The operation request is received in units of queues 401 and 402. The operation request includes, for example, data flow priority and a command issuing cycle. The data flow priority indicates priority of a command stored in a queue. The command issuing cycle refers to a temporal period in which commands are stored in a queue. An example of the operation request will be described later.

The operation-control information generator 125 generates operation control information on the basis of one or more operation requests stored in the operation request storage 124. The operation control information serves to define a periodic temporal section in which command execution is permissible for each of the queues 401 and 402, as will be described in detail later.

The operation-control information receiver 126 receives the operation control information from the operation-control information generator 125 and stores the operation control information in the operation-control information storage 127.

The command selector 128 selects one of one or more commands from the queues 401 and 402, the patrol queue, and the garbage collection queue. The command selector 128 determines a queue being a command source and command acquisition timing on the basis of the operation control information. The management command receiver 121 or the I/O command receiver 122 acquires the command selected by the command selector 128 from the queue and send it to the command-completion determiner 129.

The command-completion determiner 129 determines whether or not the command selected by the command selector 128 is to be completed within the temporal section defined by the operation control information. The command-completion determiner 129 then generates schedule information. The command-completion determiner 129 sorts out the operation of the command selected by the command selector 128 into one or more sub-operations. The command-completion determiner 129 sets an execution plan for the one or more sub-operations. The schedule information refers to the execution plan, and contains order of execution of the one or more sub-operations, as will be described in detail later.

The schedule-information storage 130 stores the schedule information generated by the command-completion determiner 129.

The command-execution status storage 131 stores command execution statuses, as will be described in detail later.

The command execution unit 132 executes the one or more sub-operations contained in the schedule information in accordance with time information output from the time manager 142.

The block-management information storage 135 stores block management information containing management information for each block.

The translation-table storage 136 stores a translation table indicating a correspondence between a logical address and a physical address designated by the host 200. The translation table is used for translating a logical address into a physical address.

The encoder 137 encodes data to be written to the NAND memory 103 (hereinafter, referred to as write data) as necessary.

The temporary storage 138 temporarily stores write data and data read from the NAND memory 103 (hereinafter, referred to as read data).

The error-correction code assignor 139 generates a predefined error correction code according to an error correction method and a predefined error-correction code length, and assigns the error correction code to write data.

The error corrector 140 executes error correction to read data by the predefined error correction method.

The decoder 141 decodes encoded read data.

The time manager 142 outputs time information for use in the memory system 100. The time manager 142 represents, for example, a timer. The time manager 142 is configured to synchronize with the time manager 213 of the host 200.

The patroller 143 executes patrolling in accordance with a patrol command stored in the patrol queue. The patrol command refers to a command for instructing a patrolling, and is issued by the storage controller 101. The patrolling refers to checking whether or not data is normally read from the NAND memory 103 to rewrite the data as necessary. Issuance of the patrol command is triggered by time, for example.

The garbage collector 144 executes garbage collection in accordance with a garbage collection command stored in the garbage collection queue. The garbage collection command refers to a command for instructing a garbage collection and is issued by the storage controller 101. The garbage collection refers to increasing writable pages in response to shortage of writable pages.

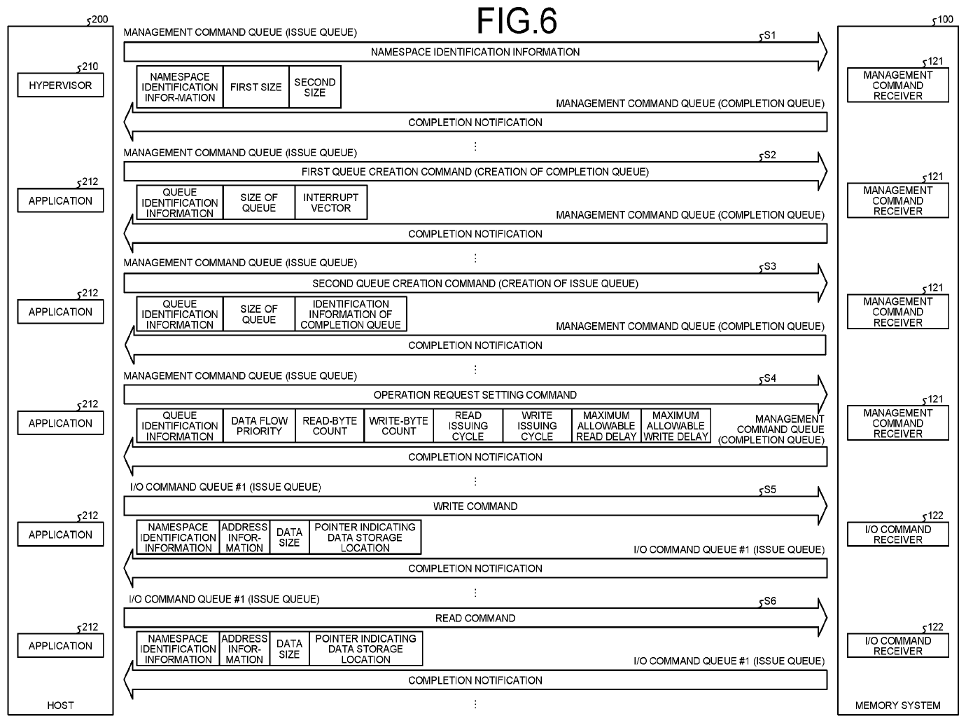

FIG. 6 is a diagram illustrating exemplary information to transmit and receive between the host 200 and the memory system 100 of the embodiment.

In FIG. 6, for example, the host 200, specifically, the hypervisor 210 or the application 212 transmits a namespace creation command to the memory system 100 before using the memory system 100 (S1). The namespace creation command includes namespace identification information (that is, NID), a first size, and a second size of a new namespace. The second size indicates a capacity, specifically, a user capacity, of the new namespace. The first size is found by adding a spare size to the second size and serves as a parameter for controlling amount of overprovisioning.

The memory system 100 first checks error in the namespace creation command. For example, the memory system 100 determines error if the first size is smaller than the second size. With no error found, the memory system 100 assigns the number of blocks corresponding to the second size to the new namespace specified by the namespace creation command. The memory system 100 assigns blocks according to the block management information.

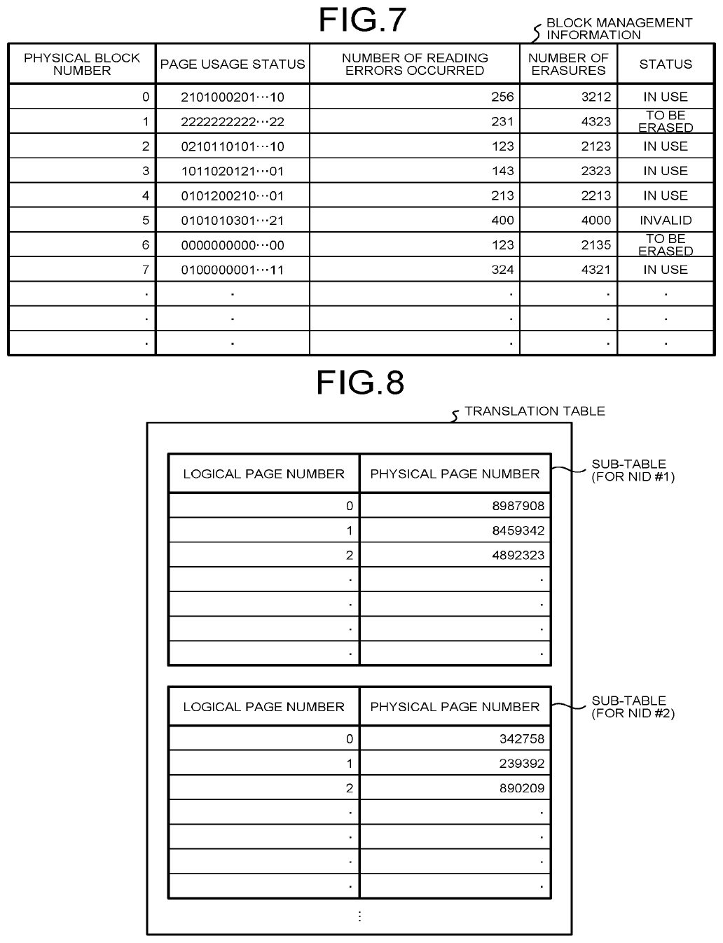

FIG. 7 is a schematic diagram illustrating exemplary block management information in the embodiment.

The block management information contains a page usage status, the number of read errors occurred, the number of erasures, and a status of each block. The blocks are identified by block numbers.

The page usage status represents use state of pages in each block. For example, the page usage status of an unused, i.e., writable, page is set to zero. The page usage status of a page being in use, that is, not writable, is set to one. The page usage status of a used page to be erased is set to two. The page usage status of an invalidated page due to error is set to three.

The number of read errors occurred represents the number of error detections through the error correction in a read operation to any page of the block. Correctable errors and uncorrectable errors may be counted separately.

The number of erasures represents the number of erasures executed after manufacturing.

The status represents any of values indicating “in use”, “to be erased”, “erased”, and “invalid”. A value indicating “in use” is set to a block including at least one page being used. A value indicating, “to be erased” is set to a block including no page being used and from which data is immediately erasable. A value indicating “erased” is set to a block in which all the pages have been subjected to data erasure and are thus writable. A value indicating “invalid” is set to a block in which read error has occurred a given number of times or more or uncorrectable error has occurred previously. “Invalid” indicates prohibition of the use of a block.

The memory system 100 manages the number of writable pages in the entire memory system 100 by the block management information. The memory system 100 generates a writable block when expecting a shortage of writable pages. For example, the number of writable pages may be managed on a namespace basis. The memory system 100 may determine a shortage of writable pages, for example, when the number of writable pages falls below a predetermined threshold.

Although not illustrated, the block management information may include information for finding a block being low in page usage rate, in order to rapidly find a block to be erased.

A block assigned to a new namespace is prepared as follows, for example. That is, an erased block is searched for with reference to the block management information. Then, the usage statuses of all the pages of the erased block are set to zero, and the number of the pages of the block is added to the number of writable pages. This makes it possible to assign the erased block to a new name space.

After the preparation of the number of blocks corresponding to the second size to be assigned to the new namespace, the translation table is set.

FIG. 8 is a schematic diagram illustrating an exemplary translation table in the embodiment.

As illustrated in FIG. 8, the translation table contains one or more sub-tables for each namespace. The sub-table stores one or more pairs of a logical page number and a physical page number. The logical page number represents a value obtained by dividing a logical block address (LBA) range of the namespace depending on a page size. For example, as to a page size of 4 KiB, an LBA range from 0 to 4095 is assigned with a logical page number “0”, and an LBA range from 4096 to 8191 is assigned with a logical page number “1”. The physical page number represents an identification number of each page of the NAND memory 103.

The sub-tables for the new namespace is added to the translation table, completing the creation of the new name space.

Referring back to FIG. 6, after completing the creation of the namespace, the memory system 100 transmits a completion notice of the execution of the namespace creation command to the host 200 using the completion queue of the management command queue 401. The application 212 operating on the host 200 can recognize completion of the creation of the namespace by the notice.

The memory system 100 transmits, to the host 200, a completion notice of the execution of not only the namespace creation command but also the management command using the completion queue of the management command queue 401. The memory system 100 transmits a completion notice of the execution of the I/O command to the host 200 using the completion queue of the I/O command queue 402. The following will omit describing the completion notice.

After completion of the creation of the namespace, the application 212 operating on the host 200 first transmits a first queue creation command for creating the completion queue of the I/O command queue 402 (S2) and then transmits a second queue creation command for creating the issue queue of the I/O command queue 402 (S3).

The first queue creation command includes queue identification information (QID), a queue size, and an interrupt vector issued from the memory system 100 upon completion of the execution of the I/O command. The second queue creation command includes queue identification information (QID), a queue size, and identification information of a corresponding completion queue.

The memory system 100 generates the completion queue in response to the first queue creation command in S2, and generates the issue queue in response to the second queue creation command in S3, thereby completing one I/O command queue 402. The memory system 100 may perform the operations in S2 and S3 in units of the I/O command queue 402.

After completion of the creation of the I/O command queue 402, the application 212 can set an operation request with respect to the created I/O command queue 402. Specifically, the application 212 transmits the operation request setting command to the memory system 100 (S4).

The operation request setting command includes queue identification information (QID) of the issue queue of an intended I/O command queue 402, data flow priority, a read-byte count, a write-byte count, a read issuing cycle, a write issuing cycle, an allowable read delay, and an allowable write delay. These items of information contained in the operation request setting command correspond to the operation requests.

The data flow priority can be represented by a 16-bit number, for example, with 0 being highest priority and 65535 being lowest priority. The read-byte count and the write-byte count serve to specify the maximum byte counts of a read command and a write command issued by a single command using an intended queue. The read issuing cycle and the write issuing cycle represent set issuing cycles of the read command and the write command. The allowable read delay and the allowable write delay represent allowable amounts of delay set in reading and writing data, that is, maximum values (worst) of delay. Such command parameters may be set to specify either reading or writing. For example, the read-byte count or the write-byte count may be set to zero to indicate no data read or write. Further, in the situation such as best-effort that the byte counts, the issuing cycles, and the allowable delays cannot be defined, the memory system 100 may be able to provide a notice of best-effort. In this case, for example, the allowable delay may be set to zero.

The operation request setting command is stored in the issue queue of the management command queue 401. The memory system 100 receives the operation request setting command from the issue queue of the management command queue 401, and performs an operation in accordance with the operation request setting command.

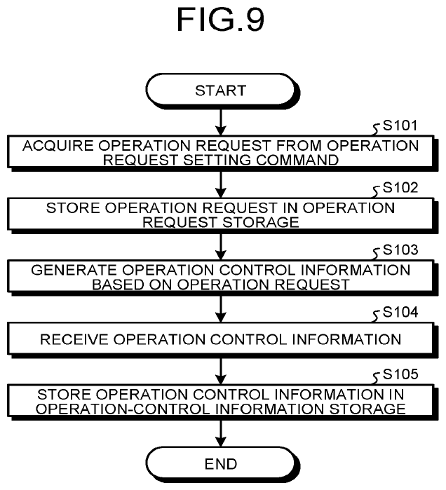

FIG. 9 is a flowchart illustrating an exemplary operation of the memory system 100 of the embodiment in response to the operation request setting command.

First, the management command receiver 121 acquires the operation request setting command from the issue queue of the management command queue 401, and transmits the operation request setting command to the operation request receiver 123 via the command selector 128 and the command-completion determiner 129. The operation request receiver 123 acquires an operation request from the operation request setting command (S101). The operation request receiver 123 stores the operation request in the operation request storage 124 (S102). The operation request receiver 123 stores the operation request in association with the queue identification information. If there are two or more operation requests associated with the same queue identification information, among the operation requests, the most lately stored operation request is considered valid.

The operation-control information generator 125 reads all the valid operation requests stored at present from the operation request storage 124, and generates operation control information on the basis of all the read valid operation requests (S103).

The operation-control information receiver 126 receives the operation control information from the operation-control information generator 125 (S104), and stores the operation control information in the operation-control information storage 127 (S105).

Consequently, the operation according to the operation request setting command is completed.

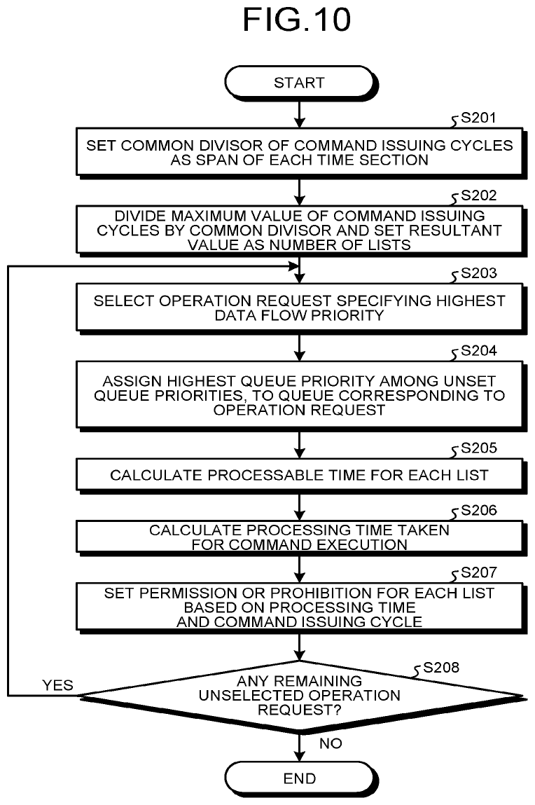

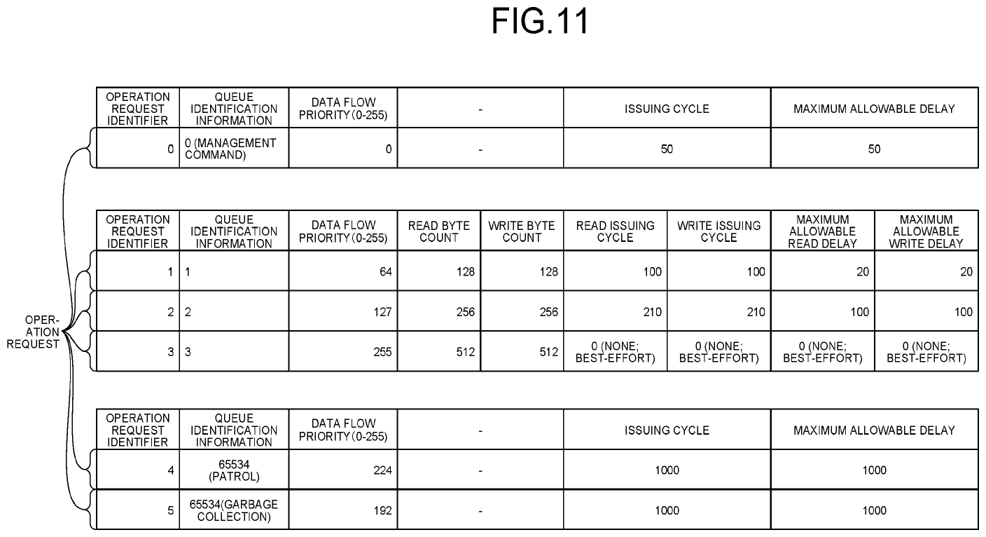

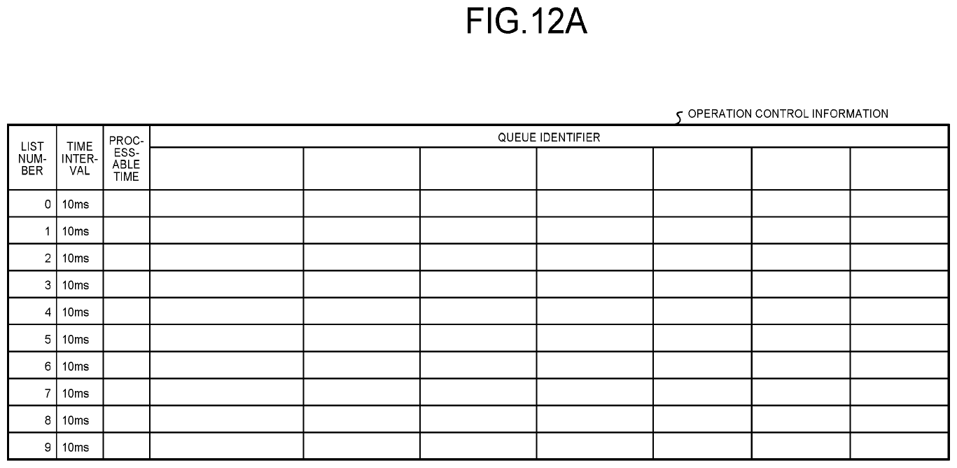

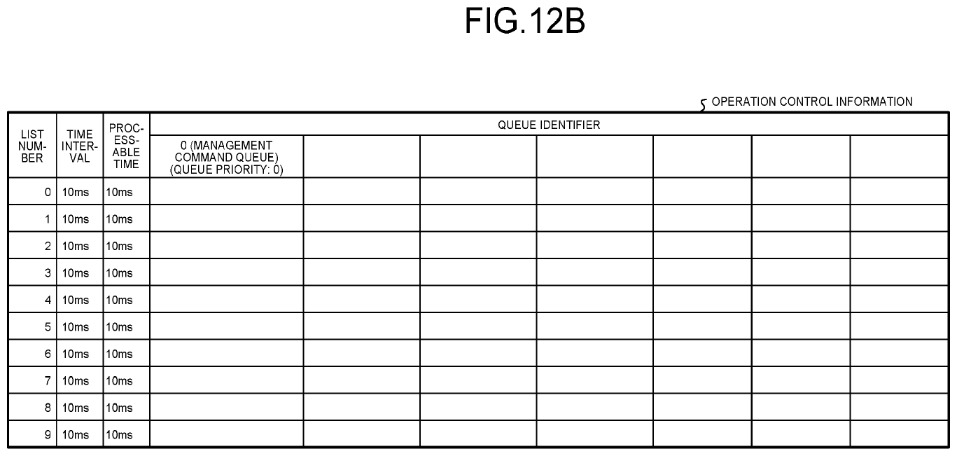

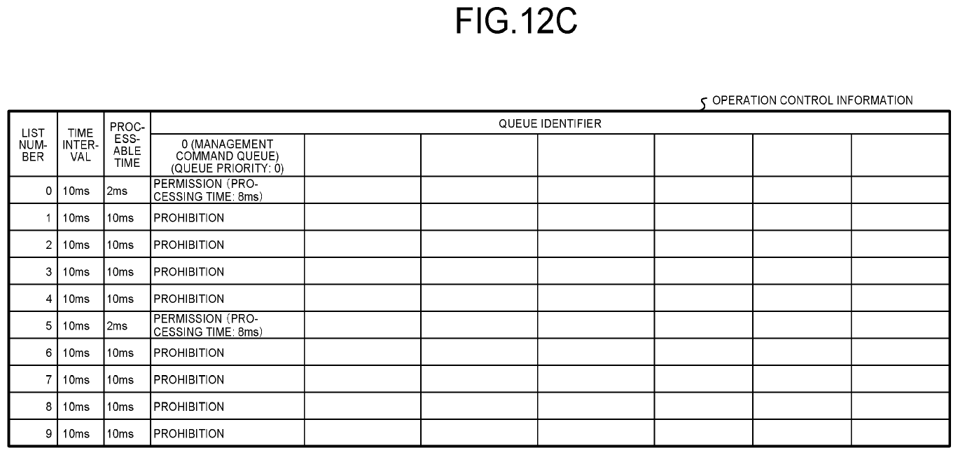

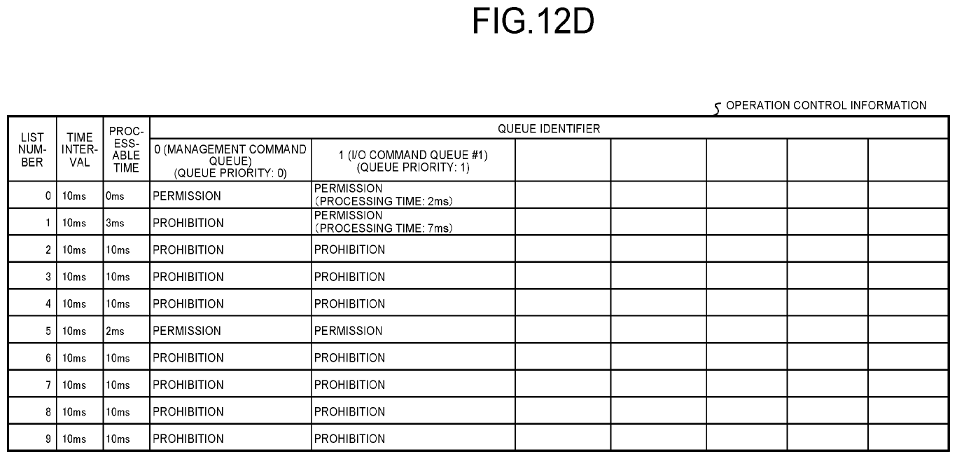

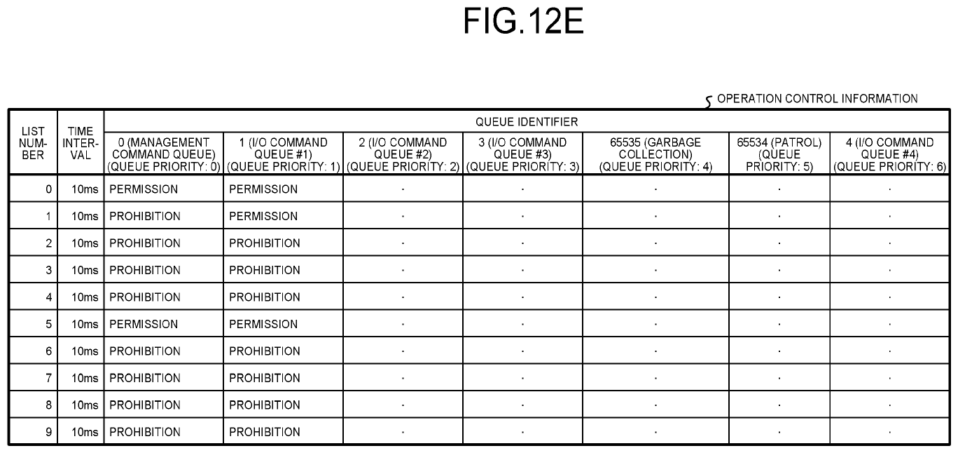

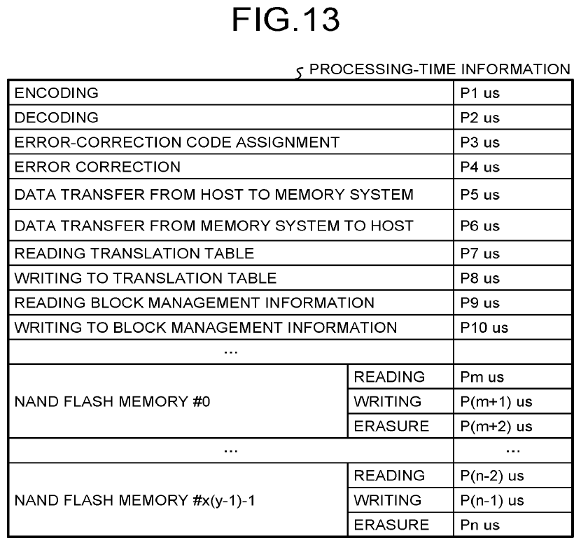

The generation of the operation control information, that is, the operation in S103 will be specifically described with reference to FIGS. 10, 11, 12A to 12E, and 13. FIG. 10 is a flowchart illustrating an exemplary operation of the memory system 100 for generating the operation control information in the embodiment. FIG. 11 is a diagram illustrating one or more operation requests in the embodiment by way of example. FIGS. 12A to 12E are diagrams illustrating examples of the operation control information during or after generation in the embodiment. FIG. 13 is a diagram illustrating exemplary processing-time information in the embodiment.

As described above, the operation control information serves to define periodic temporal section in which command execution is permissible. Specifically, a one cycle period is divided into a plurality of temporal sections, and the operation control information defines permission and prohibition of command execution in each temporal section. The operation control information contains a plurality of lists that defines different temporal sections. The lists are denoted by individual list numbers ordered in a time series within one cycle period. Each list contains either permission or prohibition set for each queue. The permission refers to permission of command execution, and the prohibition refers to prohibition of command execution.

As illustrated in FIG. 10, the operation-control information generator 125 first acquires command issuing cycles from all the valid operation requests, and calculates a common divisor of the issuing cycles. The operation-control information generator 125 then sets the common divisor as the span of a temporal section of each list (S201). That is, in this example, all the temporal sections have the same time span.

The common divisor may be or may not be a greatest common divisor. The issuing cycles contained in the operation request with respect to the I/O command queue 402, such as the read issuing cycle and the write issuing cycle, are handled as different command issuing cycles.

Subsequently, the operation-control information generator 125 divides a maximum value of the command issuing cycles acquired from all the valid operation requests by the common divisor obtained in S201. The operation-control information generator 125 sets the resultant value obtained by the division as the number of lists (S202).

For example, among the operation requests with operation request identifiers 0 to 5 illustrated in FIG. 11, the operation request storage 124 stores an operation request #0 with the operation request identifier of 0 and an operation request #1 with the operation request identifier of 1.

The issuing cycle included in the operation request #0 is 50 (in unit of millisecond, for example), and the issuing cycle included in the operation request #1 is 100 (in unit of millisecond, for example). Thus, the operation-control information generator 125 can set 10 milliseconds, which is a common divisor of 50 milliseconds and 100 milliseconds, as the span of each temporal section in S201.

In S202, since the maximum value of the issuing cycles is 100 milliseconds, which is of the operation request #0, the operation-control information generator 125 sets the number of lists to “10” obtained by dividing 100 milliseconds by a common divisor as 10 milliseconds.

Thereby, as illustrated in FIG. 12A, for example, the operation-control information generator 125 generates the operation control information containing 10 lists in which the span or interval of the temporal section is set to 10 milliseconds. The lists are assigned with list numbers. A list with list number X may be referred to as a list #X.

The operations of S203 to S208 are a loop operation. In each loop operation, one operation request is selected, and permission or prohibition is set in each list for a queue corresponding to the selected operation request.

Specifically, the operation-control information generator 125 selects an operation request designating highest data flow priority from among unselected operation requests (S203). The operation-control information generator 125 then assigns, to the queue corresponding to the selected operation request, the highest queue priority among queue priorities having not been set to any queue (S204).

Subsequently, the operation-control information generator 125 calculates a processable time for each list (S205). The processable time refers to a remaining time of the temporal section. The remaining time of the temporal section is decreased by command execution.

For example, in an initial state, that is, in the first loop, the processable time is set to 10 milliseconds in all the 10 lists, as illustrated in FIG. 12B. In the subsequent loop operations, the list #0 and the list #5 show permission of execution of a command in a queue with priority 0, and it may take eight milliseconds of processing time to execute the command, as illustrated in FIG. 12C. In such a case the processable time is set to two milliseconds in the list #0 and the list #5, and set to 10 milliseconds in the other lists.

Subsequently, the operation-control information generator 125 calculates a processing time, that is, a length of time taken for executing the command (S206).

As described above, the operation of one command can be sorted out into one or more sub-operations. A length of time taken for each sub-operation is recorded in processing-time information.

FIG. 13 is a diagram illustrating exemplary processing-time information in the embodiment. In the example of FIG. 13, encoding, decoding, error-correction code assignment, error correction, data transfer from the host 200 to the memory system 100, data transfer from the memory system 100 to the host 200, reading the translation table, writing to the translation table, access to each die 104, i.e., read, write, and erase, correspond to sub-operations. The processing-time information contains the time taken for these sub-operations.

The time taken for each sub-operation recorded in the processing-time information is, for example, a maximum count value (worst). That is, the processing-time counter 133 counts a length of time taken for execution of each sub-operation. The processing-time counter 133 collects count values and selects a maximum value for each sub-operation. The maximum value selected for each sub-operation is recorded in the processing-time information.

Instead of the maximum value, other values such as a 99 percentile may be recorded in the processing-time information. Further, at the time of an initial use, the memory system 100 may internally execute the sub-operations a given number of times, to count a length of time taken for each sub-operation and record count values in the processing-time information.

Referring back to FIG. 10, in S206 the operation-control information generator 125 calculates the time taken for command execution, i.e., the processing time, on the basis of the processing-time information.

As for the I/O command, for example, the time taken for executing the command is set to a longer one of the processing times of the read command and the write command.

As for the I/O command being the read command, reading the translation table, reading from the NAND flash memory, error correction, decoding (if necessary), and a data transfer time from the memory system 100 to the host correspond to the sub-operations. The operation-control information generator 125 acquires the time taken for each of the sub-operations from the processing-time information, and calculates the processing time based on the acquired time.

As for the I/O command being the write command, reading the block management information, data transfer from the host to the memory system 100, encoding (if necessary), error-correction code assignment, writing to the NAND flash memory, and writing to the translation table, writing to the block management information corresponds to the sub-operations. The operation-control information generator 125 acquires the time taken for each of the sub-operations from the processing-time information, and calculates the processing time based on the acquired time.

In response to an operation request #3 with operation request identifier of 3 (see FIG. 11), that is, the one not specifying an issuing cycle or a maximum allowable delay, the operation-control information generator 125 may skip the operation of S206 and set “permitted” to all the lists in S207, as described later. Further, the operation-control information generator 125 may consider the byte count of the issued command or a parallel access to the NAND memory 103.

As for the management command, the processing-time information may contain a maximum time taken for processing each management command. For example, the processing-time information may contain not a processing time of each of the queue creation command, a queue deletion command, the namespace creation command, and a namespace deletion command, but a processing time of the command taken for a longest amount of time among such commands. In the example illustrated in FIG. 12C, the processing time of the management command is set to eight milliseconds.

The patrol queue contains the patrol command for patrolling. In patrolling operation, data is read and subjected to error check, and is rewritten as necessary. In other words, the operation by the patrol command includes, for example, sub-operations such as reading the translation table, reading from the NAND memory 103, error correction, error-correction code assignment, writing to the NAND memory 103, and writing to the translation table. The operation-control information generator 125 acquires a time taken for each of the sub-operations referring to the processing-time information, and calculates the processing time based on the acquired time.

The garbage collection queue contains the garbage collection command for garbage collection. In garbage collection, a block (referred to as a first block) including a large number of pages to be erased is selected from blocks being in use. Data in all the pages of the first block being in use is copied to another block (referred to as a second block), and then the first block is subjected to erasure. Thus, the operation by the patrol command includes, for example, sub-operations such as reading of the block management information, reading the translation table, reading from the NAND memory 103, error correction, error-correction code assignment, writing to the NAND memory 103, writing to the translation table, writing to the block management information, and erasure to the block. The operation-control information generator 125 acquires a time taken for each of the sub-operations referring to the processing-time information, and calculates the processing time based on the acquired time.

Subsequent to S206, the operation-control information generator 125 sets permission or prohibition in each list in accordance with the processing time obtained in S206 and a command issuing period (S207).

For example, in the first loop operation an operation request for the management command queue 401 may be selected. In such a case the processable time is set to 10 milliseconds in all the lists, as illustrated in FIG. 12B. With reference to the operation request #0 illustrated in FIG. 11, the issuing cycle of the management command is set to 50 milliseconds corresponding to five temporal sections, and thus permission is settable to every five temporal sections. Thus, for example, as illustrated in FIG. 12C, permission is set in the list #0 and the list #5. The processing time of the management command is eight milliseconds shorter than the processable time in the list #0 and the list #5, so that permission is set in the list #0 and the list #5, and prohibition is set in the rest of the lists.

Consider that the operation request #1 illustrated in FIG. 11 is selected in the second loop operation. With reference to the operation request #1, the command issuing cycle is set to 100 milliseconds corresponding to 10 temporal sections. Since the operation control information contains ten lists, permission is settable in any of the ten lists. For example, the command processing time is set to eight milliseconds and permission is set in the list #0. According to the example of FIG. 12C, the processable time in the list #0 is two milliseconds so that the operation of the command cannot be completed within the temporal section in the list #0. In this case, the operation-control information generator 125 can set permission in the list #1 next to the list #0. If a sub-operation corresponding to two milliseconds, of eight milliseconds of the command processing time, is performed in the temporal section of the list #0, the sub-operation corresponding to the remaining six milliseconds is performed in the temporal section of the list #0. The processable time in the list #1 is 10 milliseconds so that the sub-operation corresponding to the remaining six milliseconds can be completed within the temporal section of the list #1. To execute a command over two or more temporal sections in a divided manner, the operation-control information generator 125 may calculate the time taken for the remaining sub-operation as seven milliseconds, considering an overhead, e.g., one millisecond for each division. When the processing time is longer than the value set as the maximum allowable delay, the operation-control information generator 125 may send an error notice to a transmission source of the operation request setting command. Through such operation, the operation control information is set as illustrated in FIG. 12D.

After S207, the operation-control information generator 125 determines whether or not an unselected operation request remains (S208). If an unselected operation request remains (YES in S208), the operation-control information generator 125 executes the operation of S203 again.

Operation requests are subjected to the operations in S203 to S207 in descending order of data flow priority. With no unprocessed operation request remaining, the operation control information contains the complete setting of permission and prohibition for all the queues, for example, as illustrated in FIG. 12E. That is, with no unselected operation request remaining (NO in S208), the operation-control information generator 125 ends the generation of the operation control information in S103.

The method illustrated in FIG. 9 is merely exemplary. The method for generating the operation control information is not limited thereto. For example, the number of the lists or the span of each temporal section may be determined in advance. Moreover, the spans of the temporal sections may not be the same.

In FIG. 9, the operation requests are selected in order of data flow priority, by way of example. Operation requests specifying a smaller maximum allowable delay may be preferentially selected, for example. If there are two or more operation requests specifying the same maximum allowable delay, the one specifying higher data flow priority may be preferentially selected therefrom. If different maximum allowable delays are designated for writing and reading, the operation-control information generator 125 may apply a smaller one of the maximum allowable delay for writing and the maximum allowable delay for reading.

The series of operations illustrated in FIG. 9 is executed every time one operation request is set.

Referring back to FIG. 6, after completion of the operation control information, the memory system 100 can execute an I/O command.

For example, the application 212 issues an I/O command using the created queue (S5 and S6).

The write command includes, for example, namespace identification information, address information, a data size, and a pointer indicating a data storage location. The namespace identification information represents, for example, NID. The address information represents a head address of the memory system 100 to which data is written, and is specified by, for example, LBA. The data size represents a size of write data. The pointer indicating a storage location of write data indicates, for example, a head address of data stored in the memory 202 of the host 200. The memory system 100 can acquire write data from the location indicated by the pointer.

The read command includes namespace identification information, address information, a data size, and a pointer indicating a read-data storage location. The pointer indicating a read-data storage location indicates, for example, an address of the memory 202 of the host 200 ensured by the host 200. The memory system 100 can store read data from the NAND memory 103 in the location indicated by the pointer.

The memory system 100 performs operation on the basis of time information output from the time manager 142. The time information from the time manager 142 is synchronized with time information from the time manager 213 of the host 200. When the time information from the time manager 142 coincides with start time (not illustrated in FIGS. 12A to 12E) set in the operation control information, the memory system 100 validates a control. After validation of the control, the memory system 100 executes a command of each queue according to the operation control information.

More specifically, the memory system 100 executes command scheduling on the basis of the operation control information, and executes the command according to a result of the scheduling. The memory system 100 executes scheduling in each temporal section defined by the lists contained in the operation control information. The memory system 100 executes scheduling at switching timing between the temporal sections, or a certain period before the switching timing to avoid scheduling overhead.

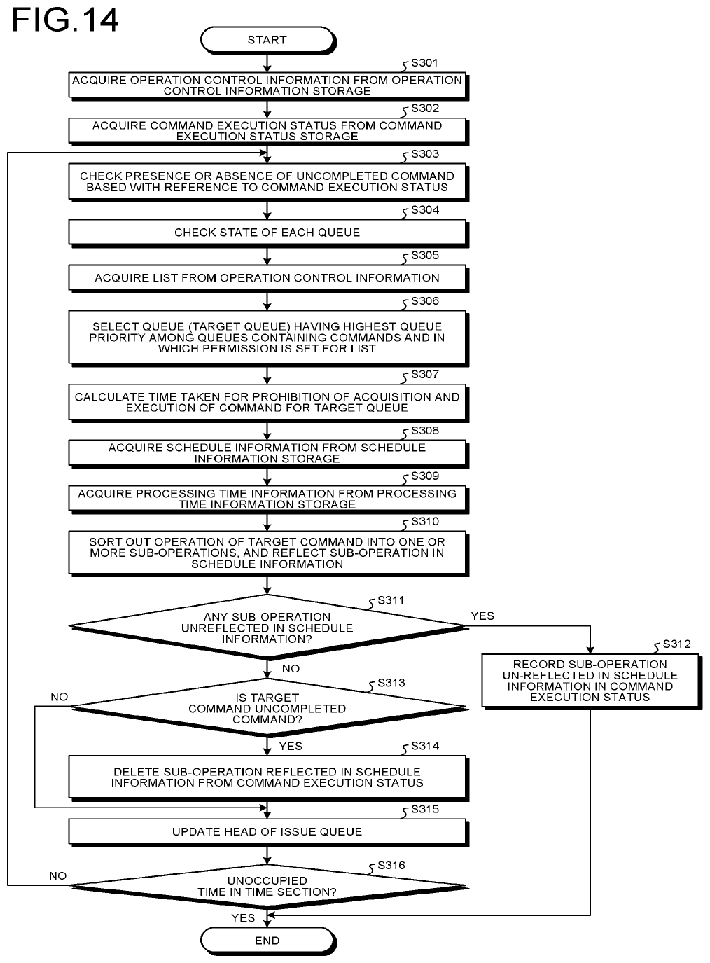

FIG. 14 is a flowchart illustrating an exemplary scheduling operation performed by the memory system 100 of the embodiment. The operation illustrated in FIG. 14 is performed on a list basis.

First, the command selector 128 acquires operation control information from the operation-control information storage 127 (S301). The command selector 128 then acquires a command execution status from the command-execution status storage 131 (S302). The command execution status refers to information containing, for each queue, remaining sub-operations of one or more sub-operations of an uncompleted command, excluding executed sub-operations.

In the scheduling operation illustrated in FIG. 14, sub-operations are added to the schedule information, as described in detail later. The command execution unit 132 executes sub-operations according to the schedule information. The sub-operations added to the schedule information may be regarded as having been executed. That is, uncompleted commands include sub-operations added to the schedule information and sub-operations not added to the schedule information.

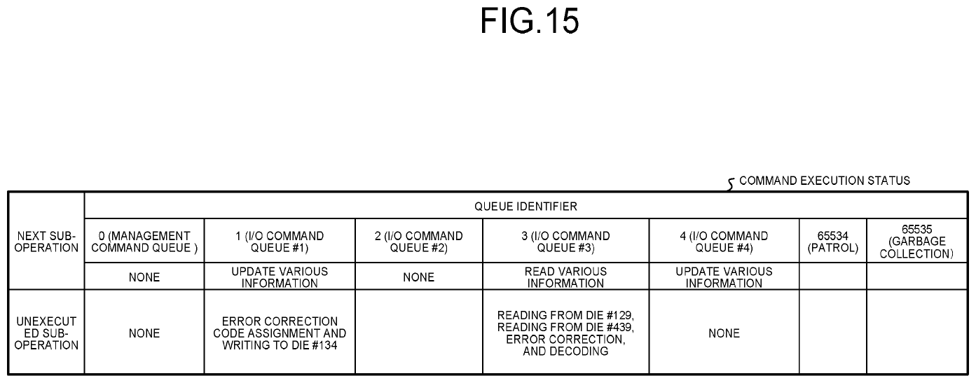

FIG. 15 is a diagram illustrating an exemplary command execution status in the embodiment. According to this example, the command execution status contains a next sub-operation and an unexecuted sub-operation for each queue. The next sub-operation refers to a sub-operation to be initially executed among the sub-operations not added to the schedule information. The unexecuted sub-operation refers to a sub-operation to be executed after the next sub-operation among the sub-operations not added to the schedule information.

As one example, the I/O command queue 402 with QID #1 contains updates of various items of information as the next sub-operation. It contains, as the unexecuted sub-operation, error-correction code assignment and writing to the die 104 with die number 134.

Referring back to FIG. 14, the command selector 128 checks a presence or absence of an uncompleted command for each queue with reference to the command execution status (S303). The queue for which any sub-operation is recorded in at least either of the next sub-operation or the non-executed sub-operation of the command execution status is regarded as a queue having an uncompleted command. The queue for which no sub-operation is recorded in at least either of the next sub-operation or the non-executed sub-operation of the command execution status is regarded as a queue having no uncompleted command.

Subsequently, the command selector 128 transmits an inquiry to the management command receiver 121, the I/O command receiver 122, the patroller 143, and the garbage collector 144 to check the statuses of the management command queue 401, the I/O command queue 402, the patrol queue, and the garbage collection queue (S304). That is, the command selector 128 determines whether these queues include any command.

The command selector 128 then acquires the lists as a subject of scheduling from the operation control information (S305). The lists are selected in order of list numbers. After selecting the list with the largest list number in the previous scheduling, the command selector 128 selects the list with the smallest list number, that is, the list #0.

The command selector 128 selects a queue with highest queue priority from among the queues storing commands and having permission set in the list (S306).

Two or more queues may satisfy the condition of S306. In such a case, the command selector 128 selects a queue with smaller QID from the queues. A queue selecting method from two or more queues satisfying the condition of S306 is not limited thereto.

The queue selected in S306 is referred to as a target queue. A command stored in an entry indicated by Head of an issue queue of the target queue is referred to as a target command. In FIG. 14, as to the command stored in the issue queue, a value of Head of the issue queue is updated after completion of the scheduling. That is, the target command can be an uncompleted command. If there are two or more queues storing commands and having permission set in the list, the command selector 128 selects the target queue according to the queue priority without considering whether or not the commands stored in the queues having permission set in the list are uncompleted commands.

Next, the command-completion determiner 129 calculates a length of time to prohibition of command acquisition and command execution of the target queue, with reference to the operation control information (S307).

The command-completion determiner 129 acquires schedule information from the schedule-information storage 130 (S308).

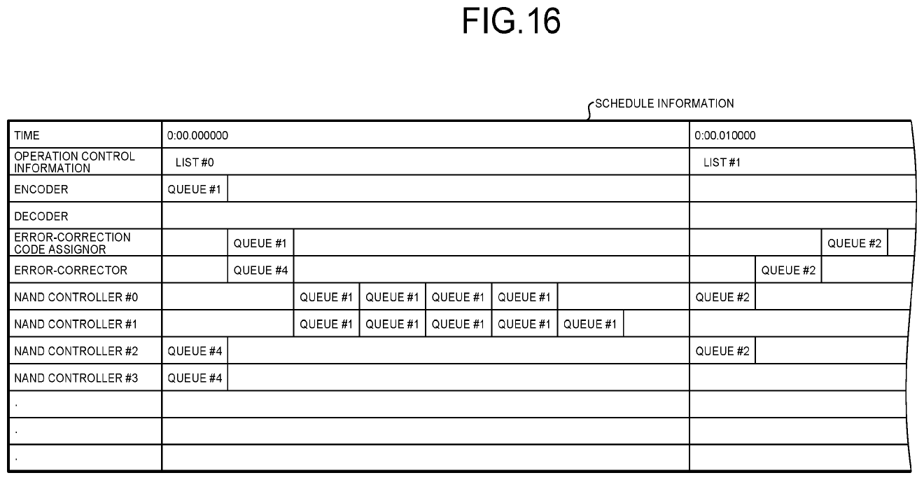

As illustrated in FIG. 16, for example, the schedule information is used to manage the internal resources of the memory system 100 such as the encoder 137, the decoder 141, the error-correction code assignor 139, the error corrector 140, and the NAND controller 102 as to which one of the queues and the commands a sub-operation to execute belongs to. The schedule information also contains information for use in each sub-operation.

Specifically, the schedule information include the respective sub-operations arranged in a chorological order. In other words, the schedule information serves as a command execution plan, more specifically, a plan of sub-operations including commands. The command execution unit 132 can execute the sub-operations in order of the arrangement in the schedule information.

A sub-operation execution plan is added to the schedule information on a list basis, that is, a temporal section basis. Thus, the schedule information read in S308 has been generated in or before the previous scheduling. In the schedule information, as illustrated in FIG. 16, each temporal section is denoted by a list number. Each temporal section contains time information.

Next, the command-completion determiner 129 acquires processing-time information from the operation-time information storage 134 (S309). Exemplary processing-time information is illustrated in FIG. 13.

The command-completion determiner 129 sorts out an operation of the target command into one or more sub-operations, and reflects, in the schedule information, one or more sub-operations executable in a period from present to prohibition of execution of the target command (S310). That is, the command-completion determiner 129 arranges the one or more sub-operations of the operation of the target command in chronological order. The command-completion determiner 129 adds, to the schedule information, one or more sub-operations to complete within the range of the temporal section among the one or more arranged sub-operations.

Regarding an uncompleted command as the target command, the schedule information has added thereto one or more remaining sub-operations of the one or more sub-operations of the operation of the uncompleted command, excluding executed sub-operation or sub-operations. The remaining sub-operation or sub-operations are recorded in the command execution status.

Subsequent to S310, the command-completion determiner 129 determines whether or not, among the one or more sub-operations of the target command, there is any sub-operation remaining unreflected in the schedule information (S311). The unreflected sub-operation in the schedule information is the one having failed to be added within the range of the temporal section.

With a sub-operation unreflected in the schedule information found (YES in S311), the command-completion determiner 129 records the reflected sub-operation in the command execution status (S312), completing the scheduling operation.

Regarding an uncompleted command as the target command, the command-completion determiner 129 deletes the sub-operation reflected in the schedule information from the command execution status and records an unreflected sub-operation in the command execution status in S312.

With no sub-operation unreflected in the schedule information found (NO in S311), the command-completion determiner 129 determines whether or not the target command is an uncompleted command (S313). After determining the target command as being an uncompleted command (YES in S313), the command-completion determiner 129 deletes the sub-operation reflected in the schedule information from the command execution status (S314).

After determining the target command as being not an uncompleted command (NO in S313) or after S314, the command-completion determiner 129 updates the value of Head of the issue queue of the target queue (S315).

Next, the command-completion determiner 129 determines whether or not there is an unoccupied time in the temporal section indicated by the list acquired through the operation in S305 (S316). This operation corresponds to determining whether to be able to execute an additional command within the temporal section.

With an unoccupied time in the temporal section found (YES in S316), the command selector 128 executes the operation of S303 again. With no unoccupied time in the temporal section found (NO in S316), the memory system ends the scheduling operation for the temporal section corresponding to the list selected by the operation of S305.

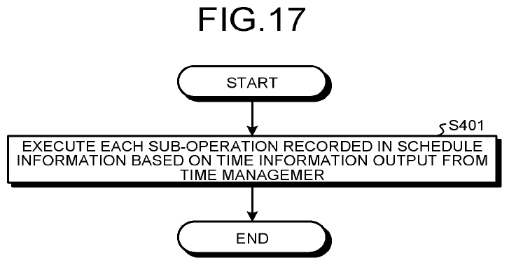

FIG. 17 is a diagram illustrating an exemplary operation of the command execution unit 132 in the embodiment. As illustrated in FIG. 17, the command execution unit 132 executes each sub-operation recorded in the schedule information according to the time information output from the time manager 142 (S401). After completing the execution of all the sub-operations recorded in the schedule information, the command execution unit 132 ends the operation.

In S401, for example, the command execution unit 132 executes data transfer between the host 200 and the memory system 100, reading from and writing to the block management information, reading from and writing to the translation table, encoding, decoding, error-correction code assignment, error correction, and access, i.e., write, erasure, or read, to the NAND memory 103, in accordance with the schedule information. The command execution unit 132 can store results of the execution of the sub-operation in the temporary storage 138.

The memory system 100 internally executes patrolling for preventing data from being lost over time and garbage collection for increasing the number of blocks to which new data is to be written. In patrolling, data are read and rewritten to another page according to a result of error correction to the read data. This makes it possible to prevent the data from becoming uncorrectable.

The memory system 100 executes patrolling at given timing. For example, the patrol command is stored in the patrol queue at certain intervals on the basis of time information output from the time manager 142. This implements the patrolling at certain intervals.

As described above, the memory system 100 executes garbage collection when the number of writable pages falls below a given threshold. For example, when the number of writable pages falls below the given threshold, the memory system 100 stores the garbage collection command in the garbage collection queue.

With respect to the patrol queue and the garbage collection queue, permission or prohibition of command execution is set in each temporal section in the operation control information according to an operation request, as with the management command queue 401 and the I/O command queue 402. The memory system 100 sets the operation request related to the patrol queue and the garbage collection queue, for example. According to the operation control information, sub-operations of the operation of the patrol command and sub-operations of the operation of the garbage collection command are added to the schedule information. By setting the data flow priority of the patrol queue and the garbage collection queue to lower than the data flow priority of the management command queue 401 and the I/O command queue 402, it is possible to execute the patrolling and the garbage collection without interrupting execution of the management command and the I/O command.

As described above, according to the embodiment, the storage controller 101 acquires and executes one or more commands from two or more queues (for example, the management command queue 401, the I/O command queue 402, the patrol queue, and the garbage collection queue) at timing based on the operation control information. The operation control information serves to define a periodic temporal section in which command execution is permissible for each of the queues.

As a result, after starting execution of a command, the memory system 100 can interrupt the execution after elapse of a temporal section assigned to a queue being a source of the command, to acquire and execute another command from another queue. That is, as long as the host 200 stores a particular command in a queue different from the other commands, the memory system 100 can start execution of the particular command at timing when a temporal section assigned to the queue storing the particular command comes. Further, the temporal section is periodic. It is thus possible to ensure the time for completing the execution of the particular command.

According to the embodiment, specifically, the storage controller 101 creates an execution plan of one or more commands stored in two or more queues, that is, schedule information, on the basis of the operation control information. The storage controller 101 executes each of the one or more first commands stored in the queues according to the operation control information.

This makes it possible to ensure the time for completing execution of a particular command.

Further, according to the embodiment, in response to end of a temporal section defined in a queue containing a certain command being executed, the storage controller 101 interrupts the execution of the command and records information on the interrupted command as a command execution status. The storage controller 101 resumes executing the interrupted command, i.e., an uncompleted command in the next temporal section.

Thus, the memory system 100 can interrupt a command being executed to execute a particular command.

Further, according to the embodiment, the queues are individually assigned with queue priority. One or more commands stored in the queues can include an interrupted command, that is, an uncompleted command. The storage controller 101 selects a command to execute from one or more commands that may include an uncompleted command, in accordance with the queue priority (for example, S306 in FIG. 14).

Consider that “permission” is set to a first queue and a second queue in a certain list. The first queue is higher in queue priority than the second queue. When a temporal section corresponding to the list comes while the first queue and the second queue both contain commands, the memory system 100 preferentially executes a command stored in the first queue over a command stored in the second queue. Irrespective of the command stored in the second queue being an uncompleted command, the memory system 100 preferentially executes the command stored in the first queue over the command stored in the second queue, in accordance with the queue priority.

Thus, as long as the host 200 stores a particular command in a queue assigned with higher queue priority, the memory system 100 can preferentially execute the particular command when a temporal section defined in the queue comes. This makes it possible to ensure the time for completing execution of the particular command.

Further, according to the embodiment, the storage controller 101 receives an operation request from the host 200 and sets a queue priority based on the operation request. That is, the queue priority is set by the operation request.

The storage controller 101 may not set the queue priority for all the queues in response to operation requests. For example, the storage controller 101 may set queue priority for part of the queues such as the patrol queue and the garbage collection queue without receiving an operation request.

According to the embodiment, the operation request includes a command issuing cycle. As specifically described with reference to FIGS. 12A to 12E, the storage controller 101 can generate the operation control information in accordance with the queue priority and the command issuing cycle.

Further, according to the embodiment, the memory system 100 can assign higher priority to the management command queue 401 and the I/O command queue 402 than the garbage collection queue or the patrol queue, thereby executing patrolling and garbage collection without interrupting execution of the management command and the I/O command.

The garbage collection queue and the patrol queue are exemplary queues containing commands issued by the memory system 100. The queues containing commands issued by the memory system 100 are not limited to the garbage collection queue and the patrol queue.

Next, modifications of the embodiment of the memory system 100 or the information operation apparatus 1 incorporating the memory system 100 will be described.

### First Modification

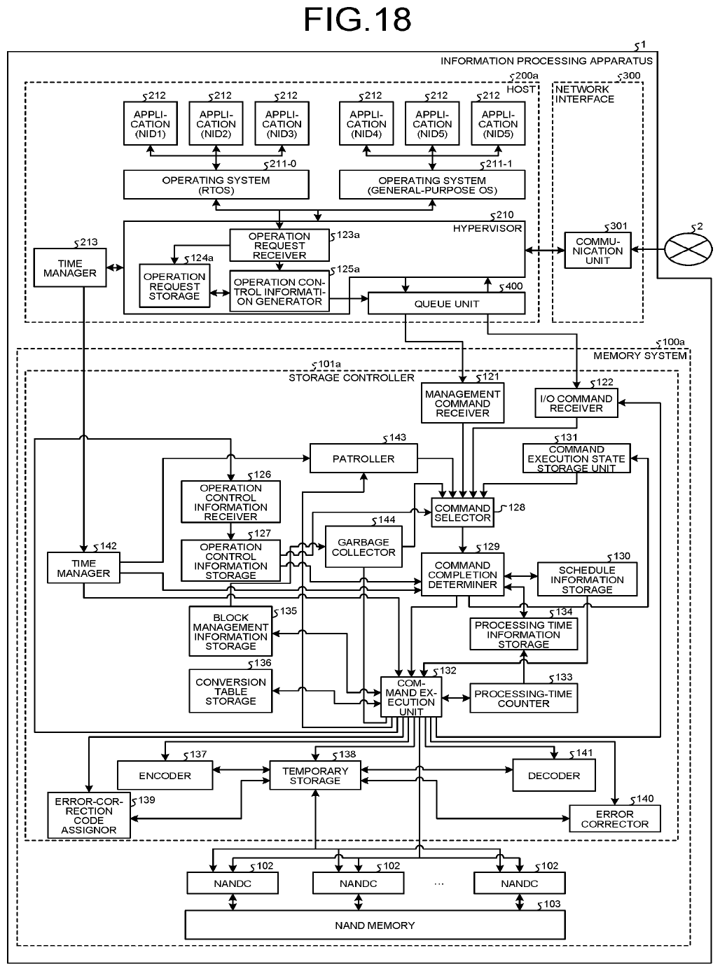

FIG. 18 is a schematic diagram illustrating an exemplary functional configuration of an information operation apparatus 1 according to a first modification. In FIG. 18, as an example, a host 200a generates operation control information. Specifically, the host 200a includes an operation request receiver 123a, an operation request storage 124a, and an operation-control information generator 125a. The operation request receiver 123a receives an operation request from the host 200a and stores the operation request in the operation request storage 124a. The operation-control information generator 125a generates operation control information on the basis of the operation request stored in the operation request storage 124a by the same method as the operation-control information generator 125. The host 200a transmits the generated operation control information to a memory system 100a. As an example, the host 200a can transmit the operation control information to the memory system 100a using the management command queue 401. The memory system 100a receives the operation control information from the host 200a and performs scheduling on the basis of the operation control information.

As such, the host 200a may generate the operation control information.

### Second Modification

The memory system 100 may be located outside the information operation apparatus 1.

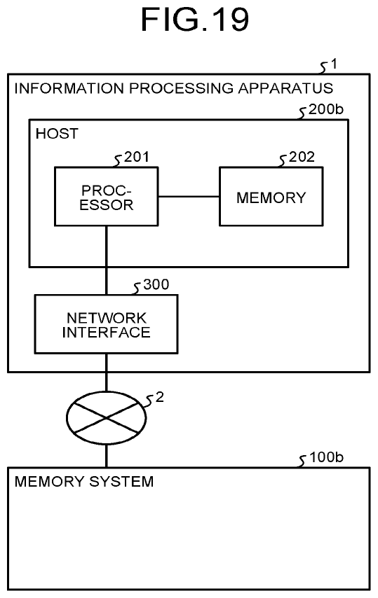

FIG. 19 is a schematic diagram illustrating an exemplary connection between a memory system 100b and an information operation apparatus 1 according to a second modification. As illustrated in FIG. 19, the memory system 100b of the second modification is connected to the information operation apparatus 1 via the network 2. The information operation apparatus 1 includes a host 200b and the network interface 300. The host 200b includes the processor 201 and the memory 202.

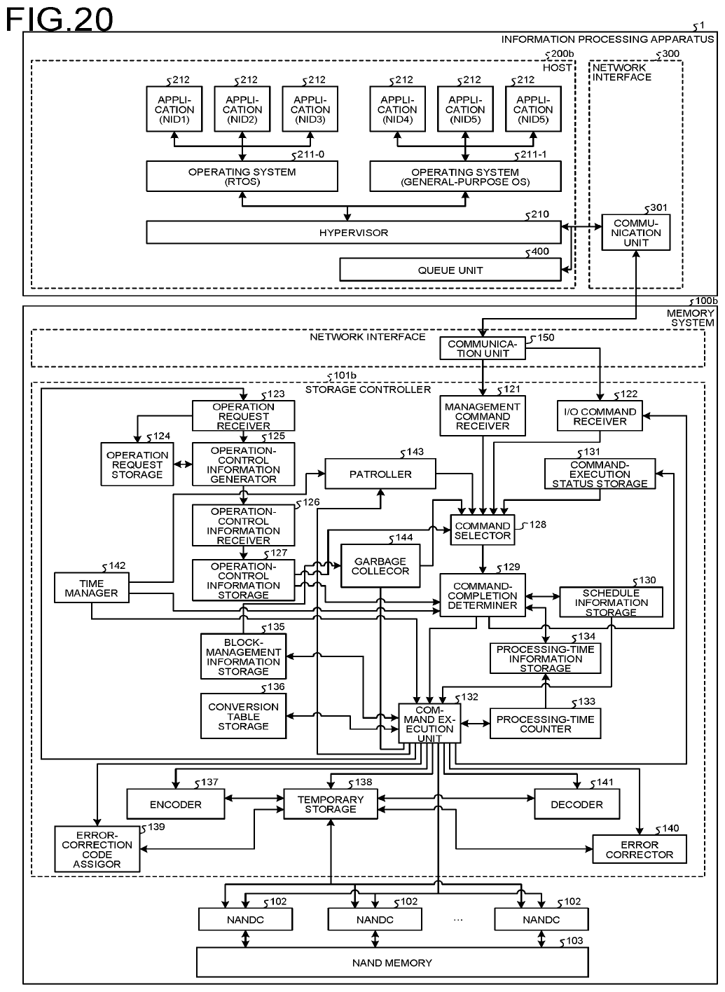

FIG. 20 is a schematic diagram illustrating exemplary functional configurations of the memory system 100b and the information operation apparatus 1 according to the second modification. As illustrated in FIG. 20, the memory system 100b includes a communication unit 150 that communicates with the information operation apparatus 1 via the network 2. The management command receiver 121 and the I/O command receiver 122 receive the management command and the I/O command via the communication unit 150, respectively.

The communication unit 150 and the communication unit 301 are mutually connected in compliance with a protocol such as NVM Express over fabrics. The time manager 142 is synchronized in time with the host 200b in compliance with a time synchronization protocol such as IEEE 1588.

As configured above, the memory system 100b, connected to the information operation apparatus 1 via, for example, Ethernet (registered trademark), can operate following the operation control information.

### Third Modification

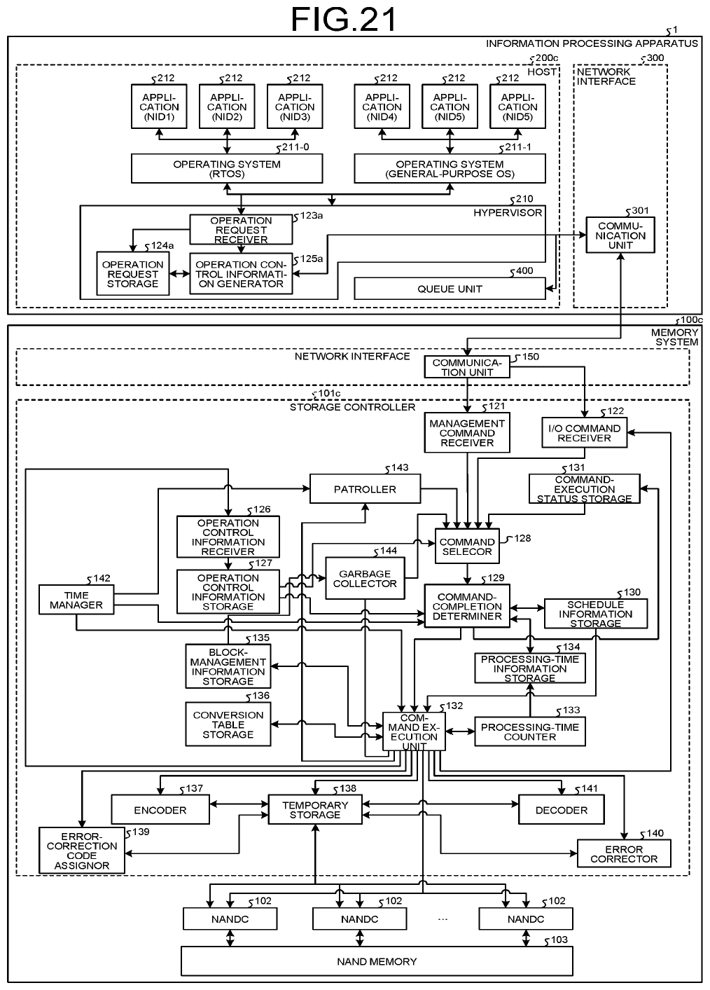

FIG. 21 is a schematic diagram illustrating exemplary functional configurations of the memory system 100 and the information operation apparatus 1 according to a third modification. As illustrated in FIG. 21, according to the third modification, a host 200c includes, as elements for generating the operation control information, the operation request receiver 123a, the operation request storage 124a, and the operation-control information generator 125a, as in the first modification. As described above, while a memory system 100c is located outside the information operation apparatus 1, the information operation apparatus 1, more specifically, the host 200c may generate the operation control information. The memory system 100c receives the operation control information from the host 200c via the communication unit 150, and performs scheduling on the basis of the received operation control information.

### Fourth Modification

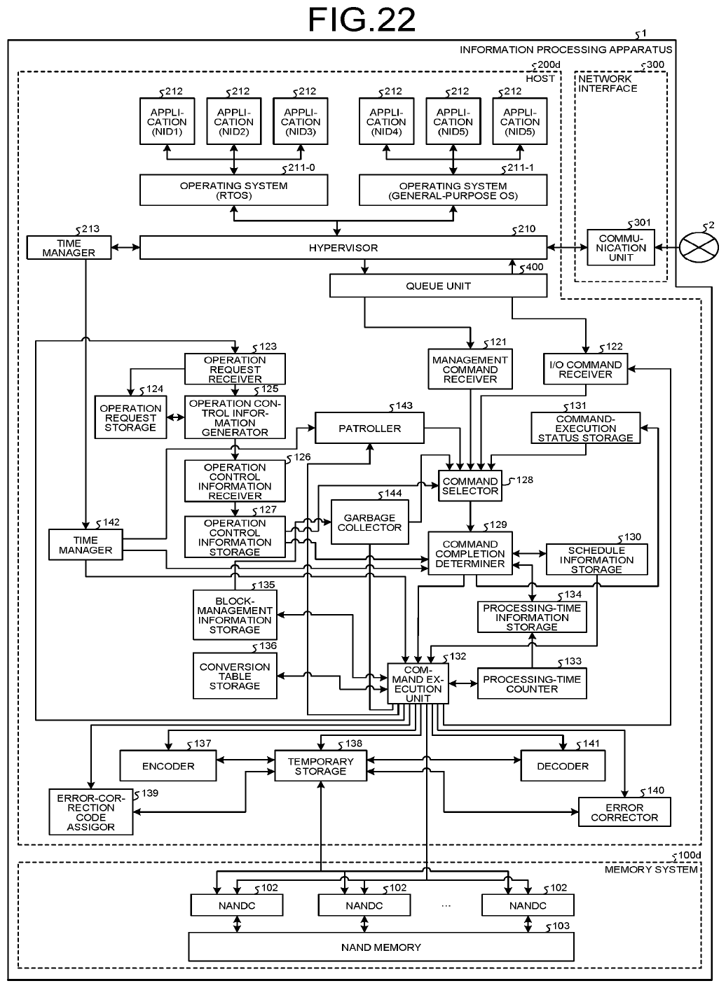

FIG. 22 is a schematic diagram illustrating exemplary functional configurations of a memory system 100d and the information operation apparatus 1 according to a fourth modification. In the fourth modification, a host 200d includes all the functional elements of the storage controller 101 illustrated in FIG. 4. Thereby, the host 200d can generate operation control information and schedule information, and controls execution of each command on the basis of the schedule information.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A memory system comprising:
a non-volatile memory; and
a memory controller configured to acquire each of one or more first commands for execution from a plurality of queues storing the one or more first commands at timing based on first information; wherein
the one or more first commands include a second command from a host, the second command being a command requiring an access to the non-volatile memory for being executed, and
the first information is information defining, for each of the queues, a periodic temporal section in which execution of a first command is permissible.

2. The memory system according to claim 1, wherein
the memory controller is configured to create an execution plan of the one or more first commands based on the first information, and execute each of the one or more first commands according to the execution plan.

3. The memory system according to claim 1, wherein
after end of a first temporal section before completion of execution of a third command among the one or more first commands of the queues, the memory controller interrupts the execution of the third command and resumes the execution of the third command in a subsequent first temporal section, the first temporal section being defined for a queue storing the third command.

4. The memory system according to claim 1, wherein
the queues are individually given priority,
the one or more first commands include a first command of which execution is interrupted, and
the memory controller is configured to select one of the one or more first commands for execution in accordance with the priority.

5. The memory system according to claim 4, wherein
the memory controller is configured to receive second information on at least one of the queues from the host, and
the priority is set by the second information.

6. The memory system according to claim 5, wherein
the second information includes the priority and an issuing cycle of a first command, and
the memory controller is configured to generate the first information in accordance with the priority and the issuing cycle.

7. The memory system according to claim 4, wherein
the one or more first commands include a fourth command issued by the memory controller, and
among the queues, a queue storing the second command is higher in priority than a queue storing the fourth command.

8. The memory system according to claim 7, wherein
the fourth command includes a command for instructing a garbage collection.

9. The memory system according to claim 7, wherein
the fourth command includes a command for instructing a patrolling.
